(19) United States
(12) Patent Application Publication
(10) Pub. No.: US 2026/0326518 A1
(43) Pub. Date: Oct. 22, 2026

(54) SUN VISOR

(71) Applicant: Shenzhen Glamortech Industrial Co., Ltd, Shenzhen (CN)

(72) Inventor: PENGBO MU, Huizhou (CN)

(21) Appl. No.: 19/700,208

(22) Filed: Jun. 6, 2026

(30) Foreign Application Priority Data
Apr. 21, 2026 (CN) 202620542724.7

(51) Int. Cl. B60J 3/02

(52) U.S. Cl. CPC B60J 3/0239; B60J 3/0252

(57) ABSTRACT

A sun visor is provided, including a sun shading sheet, a bracket portion, and at least two connection portions. The bracket portion is composed of a first clamping sheet and a second clamping sheet that are integrally formed, and is provided with a first sliding chute and a first mounting slot that are communicated with each other. A partition portion is disposed between the two slots. The sun shading sheet is detachably clamped inside the first mounting slot and is fixed to the bracket portion through a screw. The connection portions include sliding block portions, adjustment portions, and elastic clips. The sliding block portions are placed into the first sliding chute via a plugging inlet in an end portion of the bracket portion and can independently horizontally slide, to adjust a distance between the elastic clips and adapt to different in-vehicle mounting structures.

### TECHNICAL FIELD

The present disclosure relates to the technical field of sun shading, and in particular, to an in-vehicle sun visor.

### BACKGROUND

As a standard basic anti-glare accessory in a vehicle, a traditional automobile sun visor can only implement basic front shading because of a fixed sun shading area and a monotonous adjustment method. It is difficult to adapt to diverse strong light incident scenarios. Therefore, the market has put forward higher requirements for the sun shading adaptability, the adjustment flexibility, and the use convenience of a sun visor extender.

### SUMMARY

To overcome the shortcomings in the existing technology, the present disclosure provides a sun visor, including a sun shading sheet, a bracket portion, and connection portions. The sun shading sheet, the bracket portion, and the connection portions are sequentially connected.

The bracket portion includes a first clamping sheet and a second clamping sheet. A first sliding chute is formed between the first clamping sheet and the second clamping sheet. The connection portions are capable of moving within the first sliding chute in a horizontal direction.

In an improvement of the present disclosure, the connection portions include sliding block portions, adjustment portions, and elastic clips. The sliding block portions, the adjustment portions, and the elastic clips are sequentially connected. The sliding block portions are capable of moving within the first sliding chute in a horizontal direction. The adjustment portions are configured to adjust angles between the sliding block portions and the elastic clips.

In an improvement of the present disclosure, the connection portions have limiting portions. A first stop protrusion extends from an interior of the first sliding chute. The first stop protrusion is configured to stop the limiting portions within the first sliding chute.

In an improvement of the present disclosure, sliding protrusions are arranged on the connection portions, and the sliding protrusions abut against an inner wall of the first sliding chute.

In an improvement of the present disclosure, the bracket portion further includes a first mounting slot. The first mounting slot is configured to mount the sun shading sheet. A partition portion is formed between the first sliding chute and the first mounting slot. The first mounting slot and the first sliding chute are separated by the partition portion.

In an improvement of the present disclosure, the sun visor includes at least two connection portions. The at least two connection portions are capable of moving horizontally within the first sliding chute to adjust a distance between the two connection portions.

In an improvement of the present disclosure, the first sliding chute includes a first limiting narrow slot and a first passage communicated with the first limiting narrow slot. The first limiting narrow slot and the first passage are arranged sequentially from top to bottom along the bracket portion. An upper side of the first clamping sheet and/or the second clamping sheet extends out to form a first stop protrusion. The first limiting narrow slot is formed between the first stop protrusion and the first clamping sheet and/or the second clamping sheet. A lower side of the first clamping sheet and/or the second clamping sheet extends out to form a second stop protrusion. A second limiting narrow slot is formed between the second stop protrusion and the first clamping sheet and/or the second clamping sheet. The connection portions further include limiting posts and mounting portions. The first stop protrusion is configured to stop the limiting posts within the first passage. The limiting posts are capable of sliding within the first passage. The mounting portion extends out via the first limiting narrow slot and is connected to the elastic clips.

In an improvement of the present disclosure, the sliding protrusions are arranged on front and rear surfaces of the connection portions.

In an improvement of the present disclosure, the first sliding chute penetrates from a left side of the bracket portion to a right side of the bracket portion. A plugging opening is provided on at least one of a left side and a right side of the first sliding chute. The connection portions are plugged into the first sliding chute via the plugging opening. The bracket portion further includes a stop plug. The stop plug is configured to cover the plugging opening. The stop plug stops the connection portions within the first sliding chute.

In an improvement of the present disclosure, the sun shading sheet includes a plurality of first limiting slots, and the plurality of first limiting slots are arranged on one side of the sun shading sheet.

The stop plug includes a first clamping block, a second clamping block, and a second connection slot. The first clamping block and the second clamping block are both arranged on one side of the stop plug. The second connection slot is arranged on another side of the stop plug. The second clamping block is clamped to an interior of the first mounting slot and is clamped with the first limiting slot, to prevent the sun shading sheet from moving horizontally within the first mounting slot.

Beneficial effects of the present disclosure are as follows: The sun visor provided in the present disclosure is configured with the at least two connection portions capable of independently horizontally sliding. By the cooperation between the sliding block portions and the first sliding chute of the bracket portion, the distance between the elastic clips can be flexibly adjusted to adapt to in-vehicle mounting portions with different thicknesses and different specifications. It breaks the limitation of a monotonous mounting structure of a traditional sun visor, eliminates independent design of sun visors for different vehicle types, and has a wider application range. The adjustment portions of the connection portions are connected to the elastic clips. The elastic clips can freely rotate around the adjustment portions to implement multi-dimensional adjustment on a sun shading angle of the sun shading sheet and cope with sunlight incident scenarios in different directions and different angles. This solves the problems that the traditional sun visor can only implement front shading and has a poor anti-glare effect, and effectively prevents strong direct sunlight from affecting the driving vision.

### BRIEF DESCRIPTION OF THE DRAWINGS

For clearer descriptions of the technical solutions according to the embodiments of the present disclosure, the drawings required to be used in the description of the embodiments are briefly introduced below. The drawings in the description below are only some embodiments of the present disclosure, and those skilled in the art that other drawings can be acquired according to the drawings without creative efforts.

The present disclosure will be further explained below in conjunction with the accompanying drawings and embodiments.

FIG. 1 is a schematic diagram of a structure of a sun visor according to the present disclosure;

FIG. 2 is a cross-sectional view of a structure of a sun visor according to the present disclosure;

FIG. 3 is a schematic diagram of a structure of part A in FIG. 2;

FIG. 4 is an exploded diagram of a structure of a sun visor according to the present disclosure;

FIG. 5 is a schematic diagram of a structure of a bracket portion of a sun visor according to the present disclosure;

FIG. 6 is a schematic diagram of a structure of part C in FIG. 5;

FIG. 7 is a cross-sectional view of a structure of a bracket portion of a sun visor according to the present disclosure;

FIG. 8 is a schematic diagram of a structure of a stop plug of a sun visor according to the present disclosure;

FIG. 9 is a schematic diagram of a structure of a connection portion of a sun visor according to the present disclosure;

FIG. 10 is a schematic diagram of a structure of a clamping sleeve portion of a sun visor according to the present disclosure;

FIG. 11 is a cross-sectional view of a structure of a clamping sleeve portion of a sun visor according to the present disclosure;

FIG. 12 is a schematic diagram of a structure of a clamping body portion of a sun visor according to the present disclosure;

FIG. 13 is an exploded diagram of a structure of an adjustment portion and a sliding block portion of a sun visor according to the present disclosure;

FIG. 14 is a schematic diagram of a structure of a sliding block portion and an adjustment portion of a sun visor according to the present disclosure;

FIG. 15 is a schematic diagram of a structure of a limiting post of a sun visor according to the present disclosure;

FIG. 16 is a schematic diagram of a structure of a sun shading sheet of a sun visor according to the present disclosure; and

FIG. 17 is a schematic diagram of a structure of part B in FIG. 16.

### DETAILED DESCRIPTION OF THE EMBODIMENTS

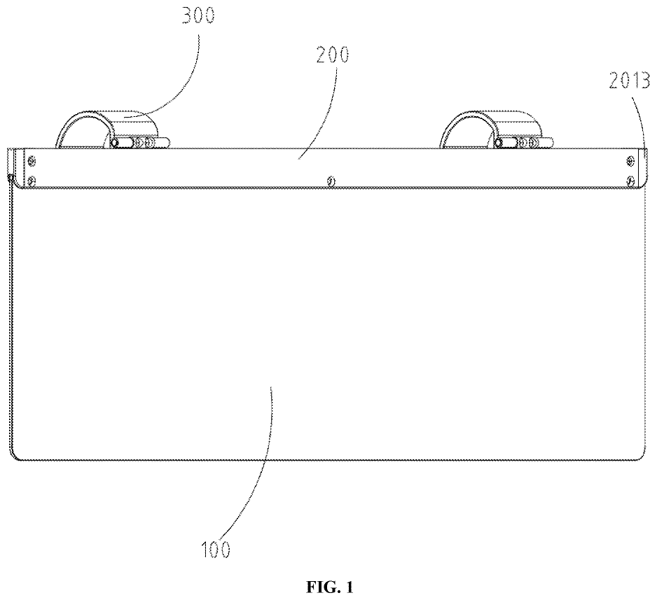

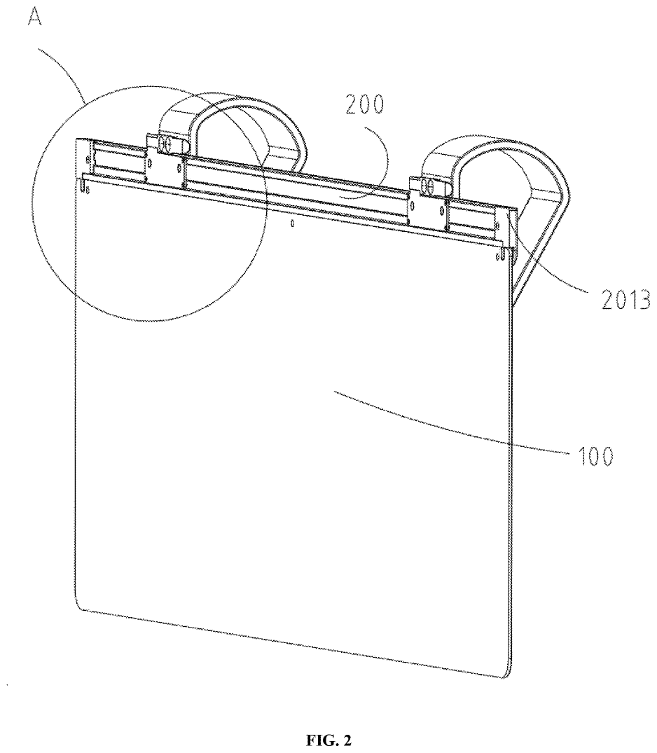

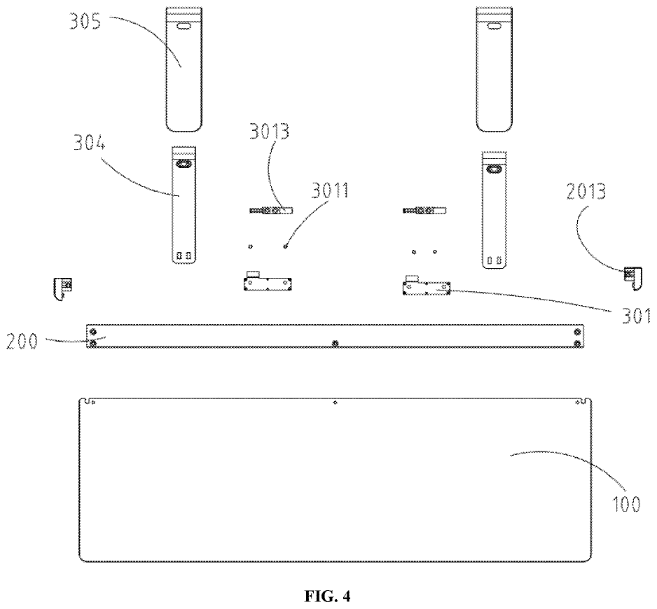

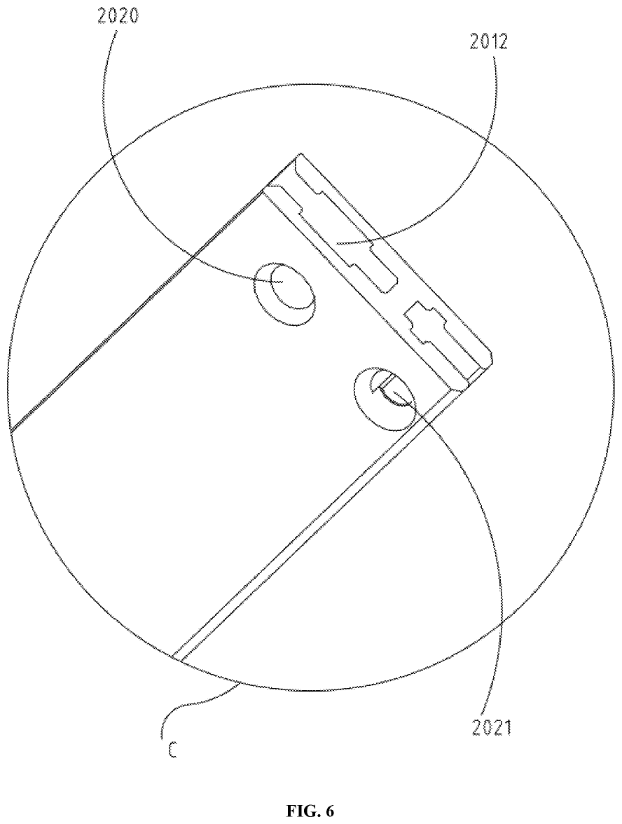

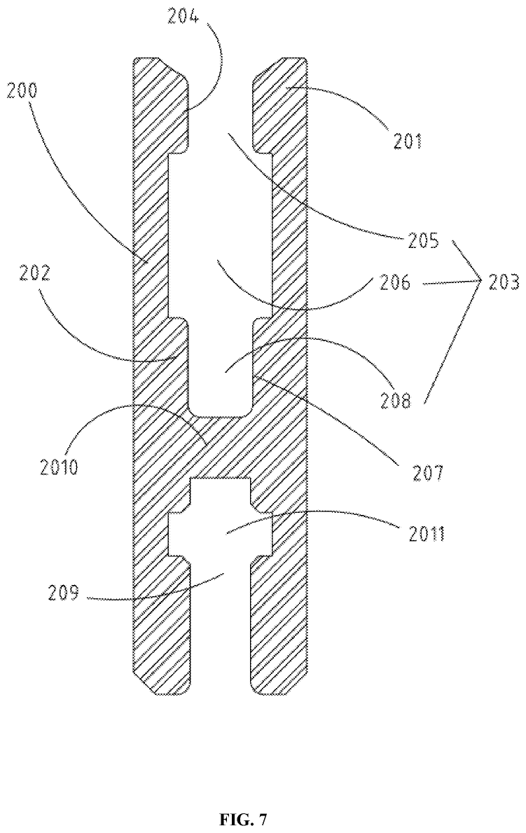

Referring to FIG. 1 to FIG. 7, in this embodiment, a sun visor includes a sun shading sheet 100, a bracket portion 200, and connection portions 300. The sun shading sheet 100, the bracket portion 200, and the connection portions 300 are sequentially connected to each other. The bracket portion 200 includes a first clamping sheet 201 and a second clamping sheet 202. The first clamping sheet 201 and the second clamping sheet 202 are integrally formed. A first sliding chute 203 is formed between the first clamping sheet 201 and the second clamping sheet 202, and the connection portions 300 can move within the first sliding chute 203 in a horizontal direction. Through the foregoing structure, the sliding block portions 301 of the connection portions 300 cooperate with the first sliding chute 203, and the sliding block portions 301 of the connection portions 300 can slide horizontally independently within the first sliding chute 203. By adjusting relative positions of different sliding block portions 301 in the first sliding chute 203, a distance between elastic clips 303 of the connection portions 300 can be adjusted.

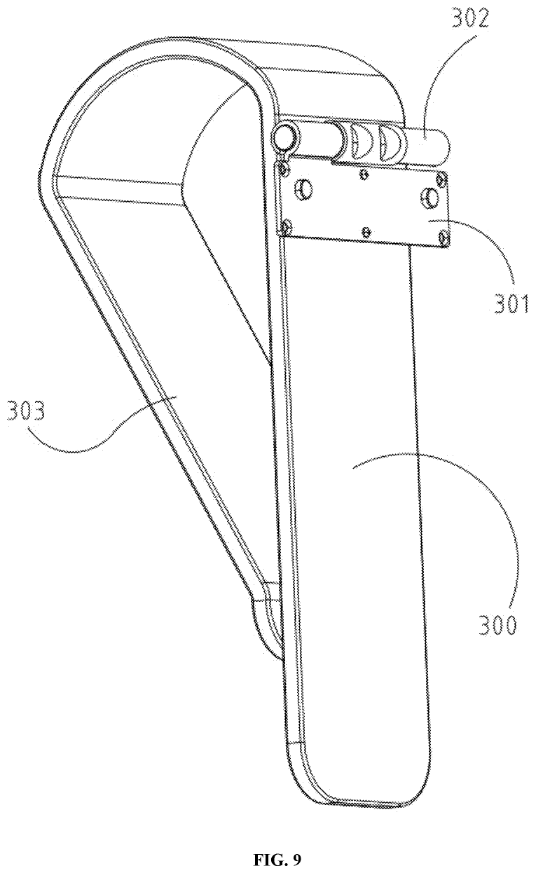

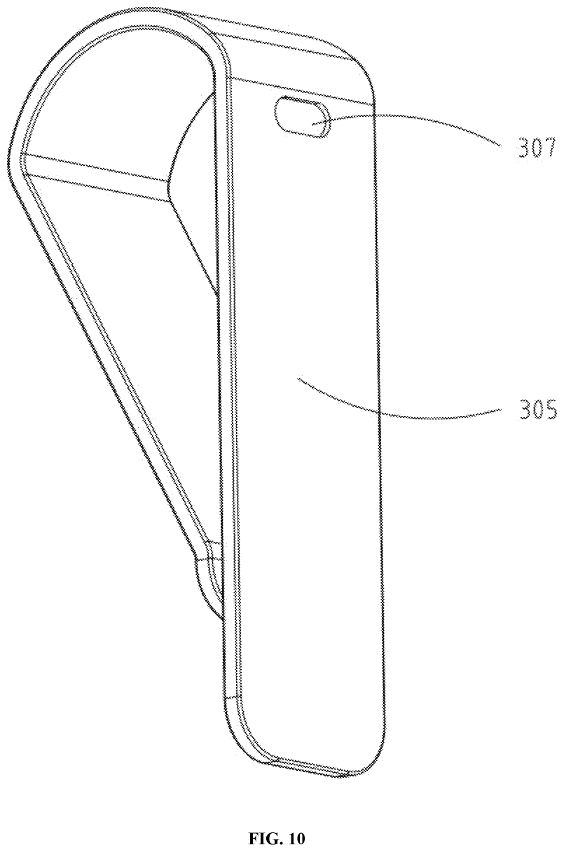

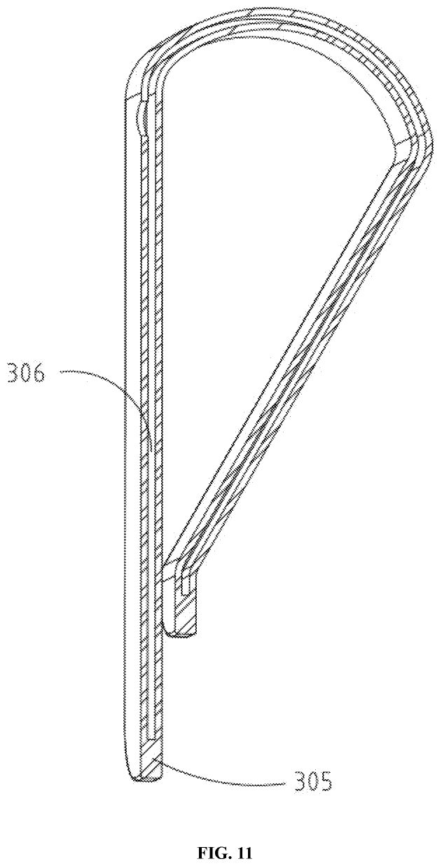

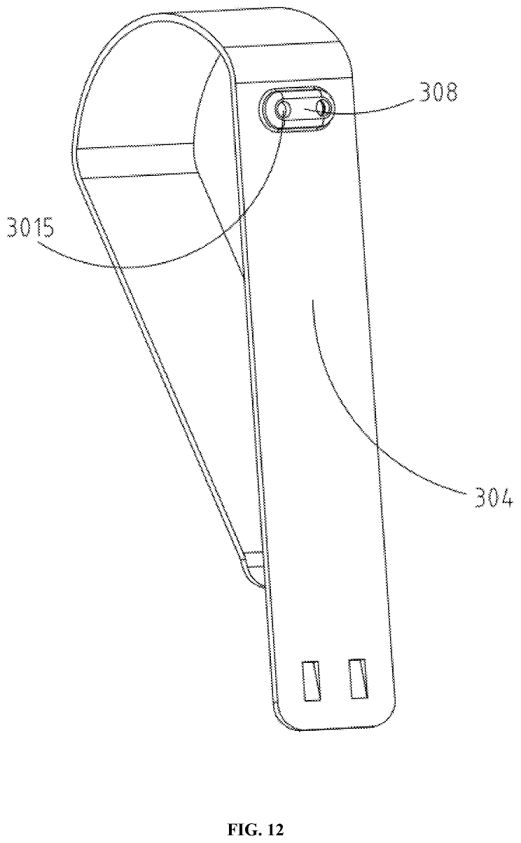

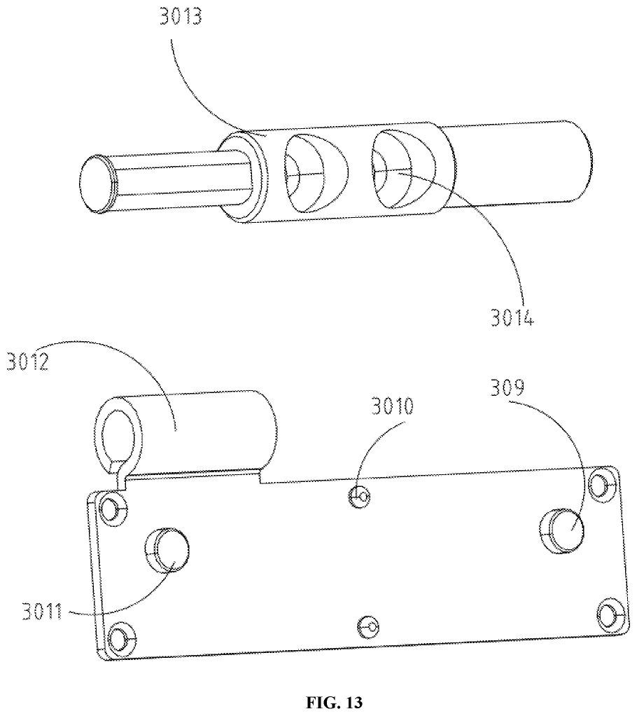

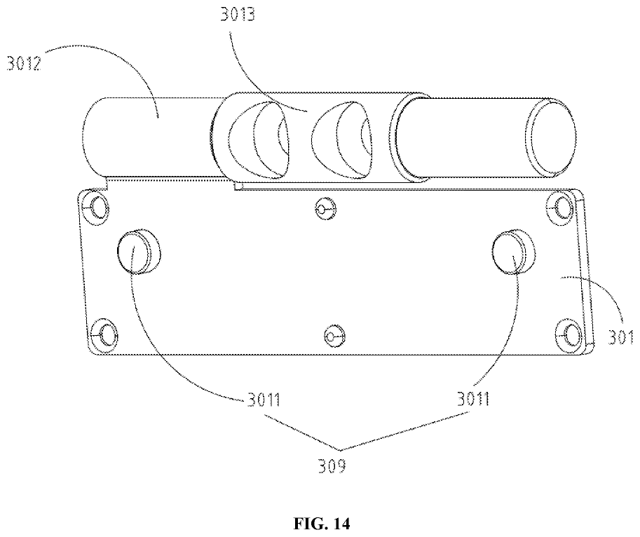

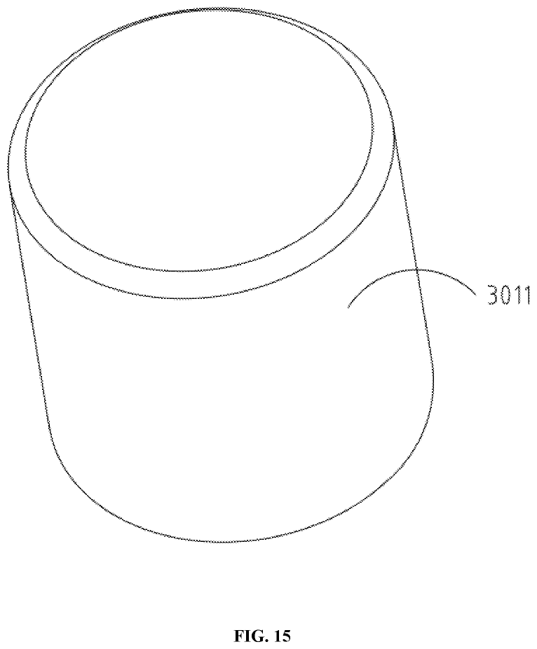

Referring to FIG. 9 to FIG. 15, in this embodiment, each connection portion 300 includes a sliding block portion 301, an adjustment portion 302, and an elastic clip 303. The sliding block portion 301, the adjustment portion 302, and the elastic clip 303 are connected sequentially. The sliding block portion 301 can move within the first sliding chute 203 in the horizontal direction. The adjustment portion 302 is configured to adjust an angle between the sliding block portion 301 and the elastic clip 303. The sliding block portion 301 can be detachably connected to the elastic clip 303 through the adjustment portion 302. The elastic clip 303 includes a clamping body portion 304 and a clamping sleeve portion 305. The clamping sleeve portion 305 includes a first receiving cavity 306. The first receiving cavity 306 is disposed within the clamping sleeve portion 305. The clamping body portion 304 is disposed within the first receiving cavity 306. The clamping sleeve portion 305 further includes a first open slot 307. The clamping body portion 304 further includes a first connection protrusion 308 corresponding to the first open slot 307. Through the foregoing structure, when the clamping body portion 304 is disposed within the first receiving cavity 306, the first connection protrusion 308 passes through the first open slot 307 and protrudes out from a surface of the clamping sleeve portion 305.

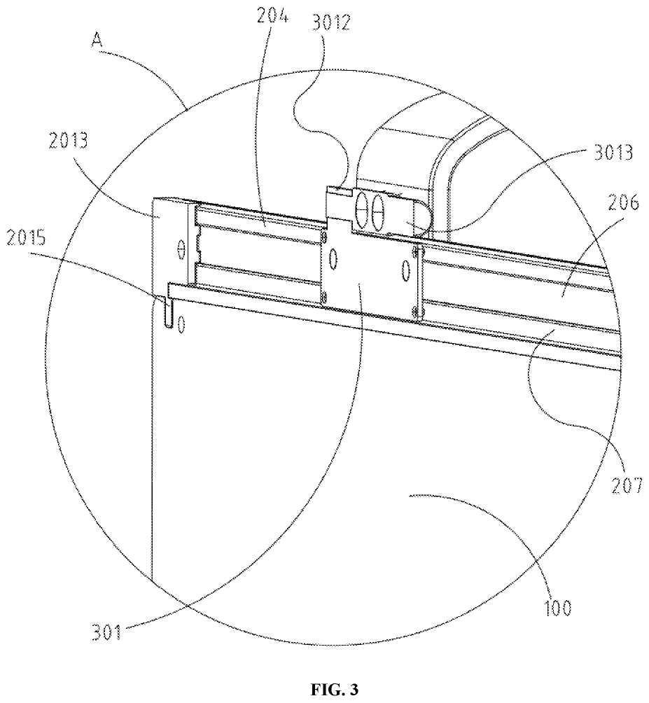

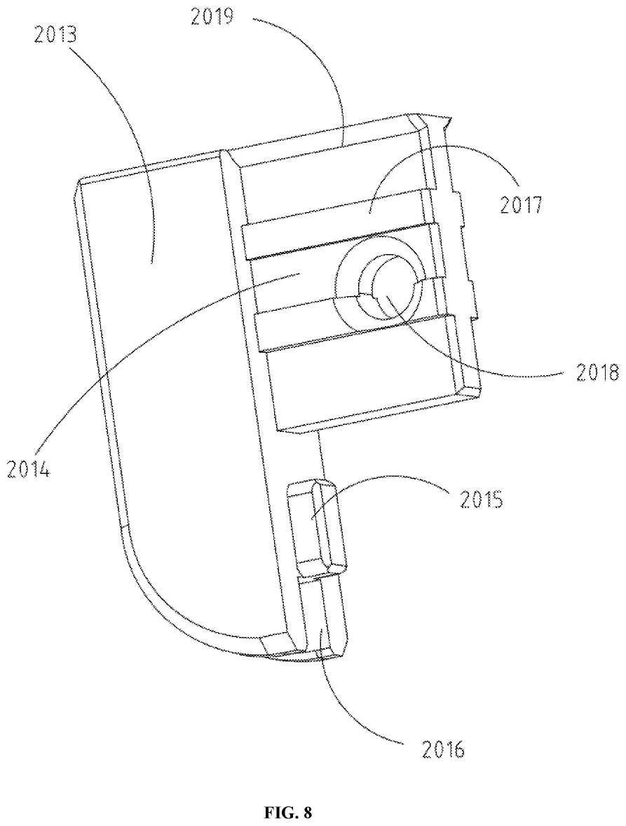

Referring to FIG. 3 to FIG. 15, in this embodiment, the connection portion 300 further has a limiting portion 309. A first stop protrusion 204 extends out from an interior of the first sliding chute 203. The first stop protrusion 204 is configured to stop the limiting portion 309 within the first sliding chute 203. The connection portion 300 is provided with a sliding protrusion 3010. The sliding protrusion 3010 abuts against an inner wall of the first sliding chute 203. The first sliding chute 203 includes a first limiting narrow slot 205 and a first passage 206 communicated with the first limiting narrow slot 205. The first limiting narrow slot 205 and the first passage 206 are arranged in sequence from top to bottom along the bracket portion 200. An upper side of the first clamping sheet 201 and/or the second clamping sheet 202 extends out to form a first stop protrusion 204. The first limiting narrow slot 205 is formed between the first stop protrusion 204 and the first clamping sheet 201 and/or the second clamping sheet 202. A lower side of the first clamping sheet 201 and/or the second clamping sheet 202 extends out to form a second stop protrusion 207. A second limiting narrow slot 208 is formed between the second stop protrusion 207 and the first clamping sheet 201 and/or the second clamping sheet 202. The first limiting narrow slot 205 and the second limiting narrow slot 208 at least partially abut against the sliding protrusion 3010. The connection portion 300 further includes a limiting post 3011 and a mounting portion 3012. Through the foregoing structure, the first stop protrusion 204 is configured to stop the limiting post 3011 within the first passage 206. The limiting post 3011 can slide within the first passage 206. The mounting portion 3012 extends out via the first limiting narrow slot 205 and is connected to the elastic clip 303. A front surface and a back surface of the connection portion 300 are both provided with the sliding protrusions 3010.

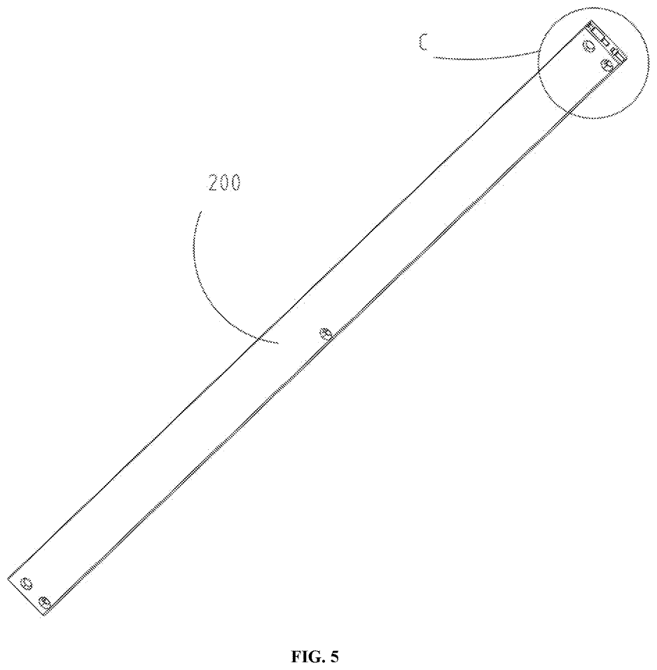

Referring to FIG. 5 to FIG. 7, in this embodiment, the bracket portion 200 further includes a first mounting slot 209. The first mounting slot 209 is arranged on one side of the bracket portion 200. The first mounting slot 209 is configured to mount the sun shading sheet 100. A partition portion 2010 is formed between the first mounting slot 209 and the first sliding chute 203. The first mounting slot 209 and the first sliding chute 203 are separated by the partition portion 2010. Through the foregoing structure, the sun shading sheet 100 is at least partially disposed within the first mounting slot 209 and abuts against the partition portion 2010. The first mounting slot 209 further includes a first connection slot 2011. The first connection slot 2011 is arranged on an inner surface of the first mounting slot 209.

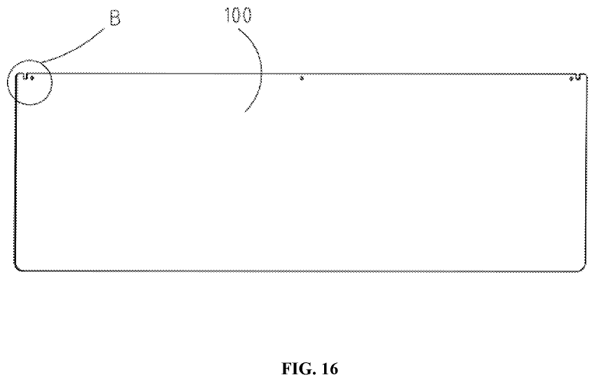

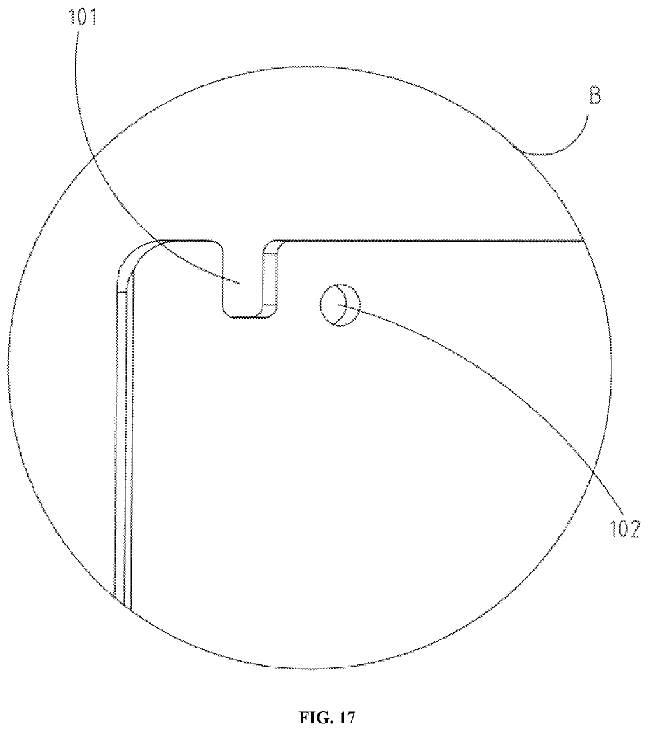

Referring to FIG. 16 to FIG. 17, in this embodiment, the sun shading sheet 100 includes a plurality of first limiting slots 101 and a plurality of first connection holes 102. The plurality of first limiting slots 101 and the plurality of first connection holes 102 are arranged on one side of the sun shading sheet 100. Through the foregoing structure, a second clamping block 2015 is clamped to an interior of the first mounting slot 209 and is limited inside the first limiting slots 101. The first limiting slots 101 are configured to: limit the sun shading sheet 100 inside the first mounting slot 209 and prevent the sun shading sheet 100 from moving horizontally within the first mounting slot 209.

Referring to FIG. 1 to FIG. 17, in this embodiment, the bracket portion 200 is further provided with a plurality of second connection holes 2020 and a plurality of third connection holes 2021. The plurality of second connection holes 2020 are distributed on one side of the bracket portion 200 and are configured to be connected with stop plugs 2013. The plurality of third connection holes 2021 are distributed on another side of the bracket portion 200. The plurality of third connection holes 2021 are configured to be connected to the sun shading sheet 100. Through the foregoing structure, when the sun shading sheet 100 is clamped to the interior of the first mounting slot 209, the third connection holes 2021 and the first connection holes 102 on the sun shading sheet 100 can be cooperatively connected through screws or pins, thereby implementing detachable connection between the sun shading sheet 100 and the bracket portion 200.

Referring to FIG. 9 to FIG. 15, in this embodiment, the adjustment portion 302 is arranged on one side of the sliding block portion 301. The adjustment portion 302 is configured to be connected to the sliding block portion 301 and the elastic clip 303. The adjustment portion 302 includes a mounting portion 3012, a connection shaft 3013, and a plurality of fixing members. The mounting portion 3012 is sleeved on one end of the connection shaft 3013. The elastic clip 303 can rotate around the adjustment portion 302 through the connection shaft 3013 that cooperates with the mounting portion 3012. The fixing members include but are not limited to pins and screws.

The connection shaft 3013 includes a plurality of fourth connection holes 3014. The elastic clip 303 includes a plurality of fifth connection holes 3015. The connection shaft 3013 and the elastic clip 303 are connected to each other through the fixing members passing through the fourth connection holes 3014 and the fifth connection holes 3015. Through the foregoing structure, the elastic clip 303 can rotate around the adjustment portion 302 through the connection shaft 3013 that cooperates with the mounting portion 3012, to implement angle adjustment on the sun shading sheet 100, thereby coping with sunlight incident in various angles and achieving a better sun shading effect.

Referring to FIG. 1 to FIG. 17, in this embodiment, the first sliding chute 203 penetrates from a left side of the bracket portion 200 to a right side of the bracket portion 200. A plugging opening 2012 is provided on at least one of a left side and a right side of the first sliding chute 203. The sliding block portion 301 of the connection portion 300 is plugged into the first sliding chute 203 via the plugging opening 2012. The sliding block portion 301 further includes a plurality of first clamping slots 3016. The plurality of first clamping slots 3016 are provided on a surface of the sliding block portion 301. A plurality of limiting posts 3011 are respectively clamped to interiors of the plurality of first clamping slots 3016. The bracket portion 200 further includes stop plugs 2013. The stop plugs 2013 are configured to cover the plugging opening 2012. The stop plugs 2013 stop the sliding block portions 301 of the connection portions 300 within the first sliding chute 203. Each stop plug 2013 includes a first clamping block 2014, a second clamping block 2015, and a second connection slot 2016. The first clamping block 2014 and the second clamping block 2015 are both arranged on one side of the stop plug 2013, and the second connection slot 2016 is provided on another side of the stop plug 2013. The first clamping block 2014 includes a plurality of first convex bars 2017, a sixth connection hole 2018, and a first stop portion 2019. Through the foregoing structure, the stop plugs 2013 are clamped to two sides of the bracket portion 200. The first stop portion 2019 is clamped with the first limiting narrow slot 205. The first clamping block 2014 is clamped to the interior of the first sliding chute 203 and abuts against an inner surface of the first sliding chute 203. The plurality of first convex bars 2017 are clamped to an interior of the first passage 206 and abuts against an inner surface of the first passage 206. The second clamping block 2015 is clamped to the interior of the first mounting slot 209 and limited within the first limiting slots 101. The first limiting slots 101 are configured to limit the sun shading sheet 100 within the first mounting slot 209 and prevent the sun shading sheet 100 from moving horizontally within the first mounting slot 209.

Referring to FIG. 1 to FIG. 8, in this embodiment, the sun shading plate includes at least two connection portions 300. The sliding block portions 301 of the connection portions 300 cooperate with the first sliding chute 203, and the sliding block portions 301 of the connection portions 300 can slide horizontally independently within the first sliding chute 203. By adjusting relative positions of different sliding block portions 301 in the first sliding chute 203, a distance between elastic clips 303 of the connection portions 300 can be adjusted. Through the foregoing structure, the sun visor adopts the at least two connection portions 300 capable of sliding independently. The horizontal sliding is implemented through the cooperation between the sliding block portions 301 and the first sliding chute 203, and the distance between the elastic clips 303 can be flexibly adjusted to adapt to in-vehicle mounting portions with different thicknesses and different specifications. It enhances the universality and the adaptation range of the sun visor. Relative positions of the sliding block portions 301 of the connection portions 300 can be separately adjusted, so that a clamping distance can be precisely controlled based on an actual use requirement, thereby ensuring that the elastic clips 303 implement firm clamping and are uniformly stressed, avoiding looseness or a mounting difficulty caused by an improper distance, and enhancing the mounting stability and use reliability of the sun visor.

The above shows one or more implementations provided in combination with specific contents, and it is not deemed that the specific implementations of the present disclosure is limited to these explanations. Any technical inferences or replacements that are similar or identical to the method and structure of the present disclosure or made under the idea of the present disclosure shall fall within the protection scope of the present disclosure.

What is claimed is:

1. A sun visor, including a sun shading sheet, a bracket portion, and connection portions, wherein the sun shading sheet, the bracket portion, and the connection portions are sequentially connected;
the bracket portion comprises a first clamping sheet and a second clamping sheet; a first sliding chute is formed between the first clamping sheet and the second clamping sheet; and the connection portions are capable of moving within the first sliding chute in a horizontal direction.

2. The sun visor according to claim 1, wherein the connection portions comprise sliding block portions, adjustment portions, and elastic clips; the sliding block portions, the adjustment portions, and the elastic clips are sequentially connected; the sliding block portions are capable of moving within the first sliding chute in a horizontal direction; and the adjustment portions are configured to adjust angles between the sliding block portions and the elastic clips.

3. The sun visor according to claim 1, wherein the connection portions have limiting portions; a first stop protrusion extends from an interior of the first sliding chute; and the first stop protrusion is configured to stop the limiting portions within the first sliding chute.

4. The sun visor according to claim 1, wherein sliding protrusions are arranged on the connection portions, and the sliding protrusions abut against an inner wall of the first sliding chute.

5. The sun visor according to claim 1, wherein the bracket portion further comprises a first mounting slot; the first mounting slot is configured to mount the sun shading sheet; a partition portion is formed between the first sliding chute and the first mounting slot; and the first mounting slot and the first sliding chute are separated by the partition portion.

6. The sun visor according to claim 1, wherein the sun visor comprises at least two connection portions; the at least two connection portions are capable of moving horizontally within the first sliding chute to adjust a distance between the two connection portions.

7. The sun visor according to claim 2, wherein the first sliding chute comprises a first limiting narrow slot and a first passage communicated with the first limiting narrow slot; the first limiting narrow slot and the first passage are arranged sequentially from top to bottom along the bracket portion; an upper side of the first clamping sheet and/or the second clamping sheet extends out to form a first stop protrusion; the first limiting narrow slot is formed between the first stop protrusion and the first clamping sheet and/or the second clamping sheet; a lower side of the first clamping sheet and/or the second clamping sheet extends out to form a second stop protrusion; a second limiting narrow slot is formed between the second stop protrusion and the first clamping sheet and/or the second clamping sheet; the connection portions further comprise limiting posts and mounting portions; the first stop protrusion is configured to stop the limiting posts within the first passage; the limiting posts are capable of sliding within the first passage; and the mounting portion extends out via the first limiting narrow slot and is connected to the elastic clips.

8. The sun visor according to claim 4, wherein the sliding protrusions are arranged on front and rear surfaces of the connection portions.

9. The sun visor according to claim 5, wherein the first sliding chute penetrates from a left side of the bracket portion to a right side of the bracket portion; a plugging opening is provided on at least one of a left side and a right side of the first sliding chute; the connection portions are plugged into the first sliding chute via the plugging opening; the bracket portion further comprises a stop plug; the stop plug is configured to cover the plugging opening; and
the stop plug stops the connection portions within the first sliding chute.

10. The sun visor according to claim 9, wherein the sun shading sheet comprises a plurality of first limiting slots, and the plurality of first limiting slots are arranged on one side of the sun shading sheet;
the stop plug comprises a first clamping block, a second clamping block, and a second connection slot; the first clamping block and the second clamping block are both arranged on one side of the stop plug; the second connection slot is arranged on another side of the stop plug; and the second clamping block is clamped to an interior of the first mounting slot and is clamped with the first limiting slot, to prevent the sun shading sheet from moving horizontally within the first mounting slot.
